(19) United States
(12) Patent Application Publication
(10) Pub. No.: US 2025/0379003 A1
(43) Pub. Date: Dec. 11, 2025

(54) ELECTROCHEMICAL DEVICE

(71) Applicant: Panasonic Intellectual Property Management Co., Ltd., Osaka (JP)

(72) Inventors: Hideo SAKATA, Osaka Fu (JP); Nobutaka TAKEDA, Osaka Fu (JP); Shohei MASUDA, Hokkaido (JP); Nobuhiro SHIMAMURA, Osaka Fu (JP)

(73) Assignee: Panasonic Intellectual Property Management Co., Ltd., Osaka (JP)

(21) Appl. No.: 18/994,728

(22) PCT Filed: Jul. 28, 2023
(86) PCT No.: PCT/JP2023/027804

§ 371 Date: Jan. 15, 2025

(30) Foreign Application Priority Data
Jul. 29, 2022 (JP) 2022-121472

(51) Int. Cl. H01G 11/26; H01G 11/06; H01G 11/34; H01G 11/42; H01G 11/50; H01G 11/60; H01G 11/62

(52) U.S. Cl. CPC H01G 11/26; H01G 11/06; H01G 11/34; H01G 11/42; H01G 11/50; H01G 11/60; H01G 11/62

(57) ABSTRACT

An electrochemical device includes a positive electrode containing a positive electrode active material reversibly doped with anions, a negative electrode containing a negative electrode active material reversibly doped with lithium ions, and an electrolytic solution containing a solvent and a lithium salt. The lithium salt includes an imide-based lithium salt, and the positive electrode active material contains a porous carbon material. A total surface functional group amount F (meq/g) per unit weight of the porous carbon material and an area S (nm²) of a circle having an average pore diameter of the porous carbon material as a diameter thereof satisfy a relationship of 0.01≤F/S≤0.20.

### TECHNICAL FIELD

The present disclosure relates to an electrochemical device.

### BACKGROUND ART

In recent years, electrochemical devices have attracted attention that use the electricity storage principles of a lithium-ion secondary battery and an electric double layer capacitor in combination. Such an electrochemical device typically uses a polarizable electrode for its positive electrode and a non-polarizable electrode for its negative electrode. In the above configuration, the electrochemical device is expected to have both a high energy density derived from a lithium-ion secondary battery and high output characteristics derived from an electric double layer capacitor.

Patent Literature 1 proposes a lithium-ion capacitor including an electrolytic solution containing a film-forming agent, a solvent containing at least one cyclic or chain carbonate compound, and an electrolytic solution being a mixture of LiFSI and LiBF₄ and having a molar ratio of LiFSI to LiBF₄ of 90/10 to 30/70, wherein the concentration of the electrolytic solution in the electrolytic solution is 1.2 to 1.8 mol/L.

### CITATION LIST

### Patent Literature

[Patent Literature 1] Japanese Laid-Open Patent Publication No. 2017-216310

### SUMMARY OF INVENTION

### Technical Problem

There is a need to suppress degradation in performance of electrochemical devices.

### Solution to Problem

One aspect of the present disclosure relates to an electrochemical device including: a positive electrode containing a positive electrode active material reversibly doped with anions; a negative electrode containing a negative electrode active material reversibly doped with lithium ions; and an electrolytic solution containing a solvent and a lithium salt, wherein the lithium salt includes an imide-based lithium salt, the positive electrode active material contains a porous carbon material, and a total surface functional group amount F (meq/g) per unit mass of the porous carbon material and an area S (nm²) of a circle having an average pore diameter of the porous carbon material as a diameter thereof satisfy a relationship of 0.01≤F/S≤0.2.

### Advantageous Effect of Invention

According to the present disclosure, degradation of performance of an electrochemical device is suppressed.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a diagram schematically illustrating a part of a cross section of a porous carbon material.

FIG. 2 is a longitudinal cross-sectional view of an example of an electrochemical device.

### DESCRIPTION OF EMBODIMENTS

Embodiments of the present disclosure are described below by way of examples, but the present disclosure is not limited to the examples described below. In the following description, specific numerical values and materials may be exemplified in some cases, but other numerical values and other materials may be adopted as long as the effects of the present disclosure can be obtained. In the present description, the phrase “a numerical value A to a numerical value B” means to include the numerical value A and the numerical value B, and can be replaced with “a numerical value A or more and a numerical value B or less”. In the following description, when the lower and upper limits of numerical values related to specific physical properties, conditions, or the like are mentioned as examples, any of the mentioned lower limits and any of the mentioned upper limits can be combined in any combination as long as the lower limit is not equal to or more than the upper limit. When a plurality of materials are mentioned as examples, one kind of them may be selected and used singly, or two or more types of them may be used in combination.

The present disclosure encompasses a combination of matters recited in any two or more claims selected from multiple claims in the appended claims. In other words, as long as no technical contradiction arises, matters recited in any two or more claims selected from multiple claims in the appended claims can be combined.

An electrochemical device according to an embodiment of the present disclosure includes a positive electrode containing a positive electrode active material reversibly doped with anions, a negative electrode containing a negative electrode active material reversibly doped with lithium ions, and an electrolytic solution. The electrolytic solution has lithium-ion conductivity and contains a lithium salt and a solvent. In the electrolytic solution, the lithium salt may be dissolved in the solvent to form the lithium ions and the anions.

In the positive electrode, the anions are doped into the positive electrode active material during charging, and dedoped from the positive electrode active material during discharging. When the anions are adsorbed onto the positive electrode active material in the electrolytic solution, an electric double layer is formed to exhibit a capacity. When the anions are desorbed from the positive electrode active material, a non-Faraday current flows. The positive electrode utilizes such a phenomenon.

In the negative electrode, the lithium ions are doped into the negative electrode active material during charging, and dedoped from the negative electrode active material during discharging. In the negative electrode, a Faraday reaction in which lithium ions are reversibly absorbed and released progresses to exhibit a capacity. The wording doping of lithium ions into the negative electrode active material is a concept that includes at least a phenomenon of lithium ion absorption into the negative electrode active material, and may include, for example, lithium ion adsorption onto the negative electrode active material and chemical interaction between the negative electrode active material and lithium ions.

The lithium salt of the electrolytic solution includes an imide-based lithium salt. The positive electrode active material contains a porous carbon material (e.g., activated carbon). A total surface functional group amount F (meq/g) per unit mass of the porous carbon material and an area S (nm²) of a circle having an average pore diameter (hereinafter, also referred to as “average pore diameter d”) of the porous carbon material as a diameter thereof satisfy a relationship of 0.01≤F/S≤0.20.

The area S of the circle having the average pore diameter d as a diameter thereof is calculated from an equation π×(d/2)².

Hereinafter, F/S (meq/g/nm²) also refers to “total surface functional group density D in an average pore cross section” or simply “total surface functional group density D”. The “average pore cross section” means a cross section of a pore having an area surrounded by the contour of the inner wall surface of the pore that is the same as the area of a circle having the average pore diameter d as a diameter thereof in a cross section of a porous carbon material. The “total surface functional group density D” serves as an indicator representing the functional group density in the pores of a porous carbon material.

Usually, a porous carbon material has a hydrophilic acidic functional group (e.g., a carboxyl group, a hydroxyl group, a quinone group, or a phenolic hydroxyl group) on the surface thereof (inner wall surfaces of the pores). Such a porous carbon material has an adsorption property for solvated ions including anions derived from a lithium salt. As a result, a positive electrode having a large capacity and a low resistance can be obtained.

However, the solvated ions including the anions derived from a lithium salt in the electrolytic solution, once they migrate into the pores of the porous carbon material and are adsorbed onto the inner wall surfaces of the pores, may react with the hydrophilic acidic functional group present on the inner wall surfaces of the pores during charging to generate an acid such as HF. The generated acid may attack, for example, the solvent to generate a gas.

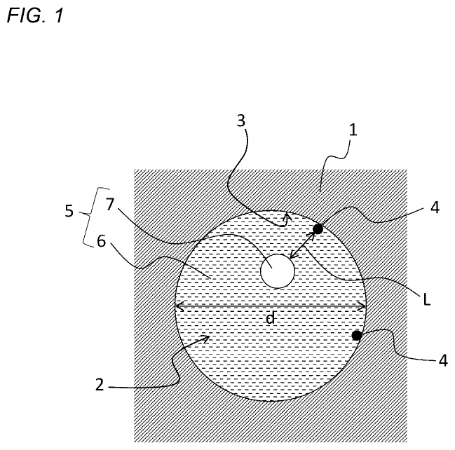

Here, FIG. 1 is a diagram schematically illustrating a part of a cross section of the porous carbon material.

A pore 2 of a porous carbon material 1 illustrated in FIG. 1 represents a pore having an average cross section. The average cross section is, for example, a cross section of the porous carbon material 1 perpendicular to the direction in which the pore 2 extends. It is assumed in this cross section that the contour of an inner wall surface 3 of the pore 2 is circular. That is, the diameter of the pore 2 is the average pore diameter d. Acidic functional groups 4 are present on the inner wall surface 3 of the pore 2. An electrolytic solution 5 enters the pore 2. The electrolytic solution 5 contains a solvent 6, anions 7, and lithium ions (not illustrated). The anions 7 can bond to the solvent 6 to form solvated ions. During charging, the anions 7 can be adsorbed onto the inner wall surface 3 of the pore 2. The total surface functional group density D varies depending on the amount of the acidic functional groups 4 present on the inner wall surfaces 3 of the pores 2 and the size (average pore diameter d) of the pores 2. As factors affecting the aforementioned side reaction (gas generation), not only the amount of the acidic functional groups 4, but also the size and stability of the anions 7, the size of the pores 2, and a distance L between the anions 7 and the inner wall surfaces 4 in the pores 2 are considered, for example. The distance L affects the sizes of the anions 7 and the pores 2.

In view of the foregoing, the present inventors conducted intensive studies focusing on the types of the anions and the total surface functional group density D. As a consequence, new findings (i) and (ii) below were obtained.

(i) When the lithium salt contained in an electrolytic solution is LiPF₆, a side reaction (HF gas generation) is likely to occur regardless of the total functional group density D. This is inferred to be because solvated PF₆⁻ has a small diameter and easily migrates into the pores.

(ii) When the lithium salt contained in an electrolytic solution is an imide-based lithium salt (e.g., LiFSI) by contrast, the degree of the side reaction (amount of generated gas) varies depending on the total surface functional group density D. It is inferred that such a phenomenon peculiar to the case with an imide-based lithium salt is influenced by the fact that the solvated imide-based anions (e.g., FSI anions) having a larger diameter than the solvated PF₆⁻ are less likely to enter the pores, and thus are less likely to decompose.

The present inventors have made intensive studies based on the above findings. As a result, it was newly found that by setting the total surface functional group density D in the range of 0.01 to 0.2 when using an imide-based lithium salt, the aforementioned side reaction and performance degradation of an electrochemical device caused by the side reaction can be reduced while ensuring a good adsorption property of the porous carbon material for solvated ions. Examples of the performance degradation of the electrochemical device includes an increase in DCR (internal resistance) due to float charging and a decrease in capacity.

When F/S is larger than 0.2, the density of the acid functional groups in the pores of the porous carbonaceous material increases, the side reaction progresses, and DCR increases during float charging.

When F/S is less than 0.01, the density of the acidic functional groups in the pores of the porous carbon material decreases, the adsorption property of the porous carbon material for the solvated ions degrades, and DCR increases during float charging.

### (Determination of Total Surface Functional Group Amount F)

The total surface functional group amount F (meq/g) per unit mass of the porous carbon material can be determined by the following method.

A sample of the porous carbon material is dried in a dryer at 115° C.±5° C. for 3 hours or more, and then allowed to cool in a desiccator for 20 minutes or more. An Erlenmeyer flask with a ground glass stopper (capacity 100 ml) was charged with 2 g±0.01 g of the sample, and further charged with 50 ml of a C₂H₅ONa solution (concentration 0.1 mol/L) as a reagent. Sample weighting is carried out to 0.1 mg digit precision. The inputs (the sample and the reagent) in the Erlenmeyer flask are stirred for 2 hours and then left to stand for 24 hours. After leaving, the inputs are stirred again for 30 minutes. Stirring is performed using a stirrer. Thereafter, the stirred product is filtered using filter paper (No. 5C) to obtain a filtrate. Titration is performed on 25 ml of the filtrate using an aqueous HCl solution (concentrated 0.1 mol/L). Titration is performed using an automatic titrator while stirring the filtrate using a stirrer. When the pH of the filtrate reaches 4.0, the titration is stopped, and a total titrant amount t1 from the start to the stop of the titration is measured. In addition, the same amount of the reagent (C₂H₅ONa solution) is titrated in the same manner without adding the sample, and a total titrant amount t2 until the pH reaches 4.0 is measured (blank test).

Based on t1 (ml) and t2 (ml) obtained as above, a total surface functional group amount F (meq/g) is calculated from the following equation (1).

$$F = 0.1 \times ( t 2 - t 1 ) \qquad ( 1 )$$

### (Determination of Average Pore Diameter d)

The average pore diameter d can be determined by the following method.

A sample of 0.20 g to 0.25 g of the porous carbon material is collected, placed in a measuring cell made from a glass tube for specific surface area measurement, and dried by degassing the inside of the measuring cell. Degassing for drying is performed at a pressure of 6.67 Pa and a temperature of 250° C.±5° C. for 1 hour or more. Thereafter, the mass of the sample in the measuring cell is measured to 0.1 mg digit precision. Then, the adsorption amount of nitrogen of the sample at a temperature of −196° C. is measured using a specific surface area measuring apparatus. As the measuring apparatus, an automated specific surface area/pore distribution measuring device “TRISTER II 3020” produced by SHIMADZU CORPORATION is used, for example. A specific surface area A is determined from the measurement results of the adsorption amount using the BET multipoint method in the range of partial pressure (relative pressure) from 0.001 to 0.2. A pore volume V is calculated from the total adsorption amount of nitrogen of the sample at which the partial pressure (relative pressure) is 0.93.

Using the determined specific surface area A (m²/g) and pore volume V (cm³/g), the average pore diameter d (nm) is calculated from the following equation (2).

$$d = ( 4 V / A ) \times 1 {0}^{3} \qquad ( 2 )$$

In determination of the total surface functional group amount F and the average pore diameter d described above, it is possible that the electrochemical device is decomposed to take out the positive electrode, and the positive electrode is washed with a solvent such as dimethyl carbonate and dried to collect the positive electrode mixture layer from the positive electrode for use as a sample. The amounts of components (such as a binder) contained in the positive electrode mixture other than the porous carbon material are small, and the influence of the other components on the determination of the total surface functional group amount F and the average pore diameter d is therefore small.

### (Porous Carbon Material)

The porous carbon material can be produced, for example, by subjecting a raw material to heat treatment for carbonization, and subjecting the resulting carbide to activation treatment to make it porous. Examples of the raw material include wood, coconut shell, pulp waste liquid, coal or coal-based pitch obtained by thermal decomposition thereof, heavy oil or petroleum-based pitch obtained by thermal decomposition thereof, phenolic resin, petroleum-based coke, and coal-based coke. Examples of the activation treatment include gas activation using a gas such as water vapor and chemical activation using an alkali such as potassium hydroxide.

The total surface functional group amount F and the area S (average pore diameter d) can be adjusted by changing the raw material, the heat treatment temperature, the activation temperature in gas activation, or the type of the chemical used, for example.

The total surface functional group amount F is 0.05 meq/g or more and 1 meq/g or less, for example. The average pore diameter d is 1.5 nm or more and 6 nm or less, for example.

The porous carbon material is usually in the form of particles. The average particle diameter of the porous carbon material is not particularly limited, but may be 1 μm or more and 20 μm or less, or may be 3 μm or more and 15 μm or less. In the present description, the average particle diameter refers to the particle diameter (median diameter) at which the cumulative volume reaches 50% in a volume-based particle size distribution measured using a laser diffraction/scattering method.

The specific surface area A of the porous carbon material is 1200 to 2500 m²/g, for example, and may be 1350 to 2300 m²/g. When the specific surface area A is 1200 m²/g or more (e.g., 1350 m²/g or more), a high capacity can be easily achieved. When the specific surface area A is 2500 m²/g or less (e.g., 2300 m²/g or less), the contact area with the electrolytic solution is reduced to inhibit decomposition of the electrolytic solution in association with side reactions. The specific surface area A is determined by the method described above.

The specific surface area and the average particle diameter of the porous carbon material may be adjusted by performing either or both pulverization and classification of the porous carbon material. Pulverization may be performed using a ball mill or a jet mill, for example.

### (Imide-Based Lithium Salt)

The lithium salt includes an imide-based lithium salt. The imide-based lithium salt is a salt constituted of a lithium ion and an imide-based anion. Examples of the imide-based anion include an imide-based anion (e.g., a fluorine-containing alkylsulfonylimide anion and a fluorosulfonylimide anion) containing a sulfur atom and a fluorine atom.

Examples of the imide-based anion include N(SO₂CₘF₂ₘ₊₁) (SO₂CₙF₂ₙ₊₁)⁻ (m and n are each independently represent an integer of 0 or more). m and n may independently represent 0 to 3 or may be 0, 1 or 2. The imide-based anion may be N(SO₂CF₃)₂⁻, N(SO₂C₂F₅)₂⁻, or N(SO₂F)₂⁻.

N(SO₂F)₂⁻ may be referred to as FSI, and lithium bis(fluorosulfonyl) imide, which is a salt of FSI⁻ and a lithium ion, may be referred to as LiFSI.

Among them, the imide-based lithium salt preferably contains LiFSI. Use of LiFSI tends to significantly reduce the DCR change rate at low temperatures. It is considered that LiFSI is effective in suppressing degradation of the positive electrode active material and the negative electrode active material. FSI⁻, which has a strong fluorine-sulfur bond, is excellent in stability. It is therefore considered that generation of HF is suppressed when compared with PF₆⁻, and contributes to smooth charging and discharging without involving damage to the active material.

The following describes each component of the electrochemical device in detail.

### (Positive Electrode)

The positive electrode active material contains at least a porous carbon material (e.g., a porous carbon material having an average particle diameter of 1 μm or more and 20 μm or less and a specific surface area A of 1200 to 2500 m²/g, such as activated carbon), and may contain a material (e.g., a conductive polymer) other than the porous carbon material. The proportion of the porous carbon material in the positive electrode active material may be 60% by mass or more, may be 80% by mass or more, and is desirably 95% by mass or more. The entire positive electrode active material may consist of the porous carbon material.

The positive electrode includes a positive electrode mixture layer and a positive electrode current collector carrying the positive electrode mixture layer, for example. The positive electrode mixture layer contains a positive electrode active material as an essential component, and may contain, for example, a conductive agent, a binder, and a thickener as optional components. The percentage content of the positive electrode active material in the positive electrode mixture layer may be 70% by mass or more, and is desirably 90% by mass or more. The thickness of the positive electrode material mixture layer is 10 to 300 μm per one side of the positive electrode current collector, for example.

Examples of the conductive agent include carbon black and carbon fibers. Examples of the carbon black include acetylene black and Ketjen black. Examples of the binder include a fluororesin, an acrylic resin, and a rubber material. Examples of the thickener include cellulose derivatives.

The positive electrode mixture layer is formed, for example, by applying a positive electrode mixture slurry prepared by mixing, for example, a positive electrode active material and a conductive agent with a dispersion medium onto a positive electrode current collector, and then drying the positive electrode mixture slurry.

A sheet-shaped metal material is used as the positive electrode current collector. The sheet-shaped metal material should be a metal foil, a metal porous body, or an etched metal, for example. As the metal material, aluminum, an aluminum alloy, nickel, or titanium can be used, for example.

### (Negative Electrode)

The negative electrode potential (25° C.) is 0.2 V or less relative to a lithium reference (vs. Li/Li⁺)”, for example. The negative electrode mixture layers are pre-doped with lithium ions so that the negative electrode potential in the electrolytic solution is 0.2 V or less relative to the metallic lithium. This lowers the negative electrode potential, increases the potential difference (i.e., voltage) between the positive electrode and the negative electrode, and increases the energy density of the electrochemical device. The amount of lithium to be pre-doped should be set to about 50% to 95% of the maximum amount that can be absorbed in the negative electrode mixture layer, for example.

Examples of the negative electrode active material include hard carbon, graphitizable carbon (soft carbon), graphite (e.g., natural graphite and artificial graphite), lithium titanium oxide (e.g., spinel-type lithium titanium oxide), silicon oxide, a silicon alloy, tin oxide, and a tin alloy.

Among them, the negative electrode active material preferably contains hard carbon. Hard carbon has a lower resistance and a higher capacity than graphite. When hard carbon is used, a negative electrode can be easily obtained that exhibits a low DCR at low temperatures and that experiences slight expansion and shrinkage due to charging and discharging. Hard carbon has better compatibility with propylene carbonate than graphite, and tends to reduce DCR.

The hard carbon may have a surface spacing (i.e., surface spacing between a carbon layer and a carbon layer) d002 on the (002) plane measured by X-ray diffractometry of 3.8 Å or more. The theoretical capacity of the hard carbon is desirably 150 mAh/g or more, for example. The hard carbon preferably accounts for 50% by mass or more of the negative electrode active material, more preferably 80% by mass or more, and further preferably 95% by mass or more. Further, the hard carbon desirably accounts for 40% by mass or more of the negative electrode mixture layer, more preferably 70% by mass or more, and further preferably 90% by mass or more.

The average particle diameter of the negative electrode active material (particularly, the hard carbon) may be 1 μm or more and 20 μm or less, or may be 2 μm or more and 15 μm or less, from the point of view that the filling property of the negative electrode active material in the negative electrode is high and side reactions with the electrolytic solution are easily inhibited.

The negative electrode includes a negative electrode mixture layer and a negative electrode current collector carrying the negative electrode mixture layer, for example. The negative electrode mixture layer contains a negative electrode active material as an essential component, and may contain, for example, a conductive agent, a binder, and a thickener as optional components. The thickness of the negative electrode material mixture layer is 10 to 300 μm per one side of the negative electrode current collector, for example.

Examples of the conductive agent include carbon black and carbon fibers. Examples of the binder include a fluororesin, an acrylic resin, and a rubber material. Examples of the thickener include cellulose derivatives.

The negative electrode mixture layer is formed, for example, by applying a negative electrode mixture slurry prepared by mixing, for example, a negative electrode active material and a conductive agent with a dispersion medium onto a negative electrode current collector, and then drying the negative electrode mixture slurry.

A sheet-shaped metal material is used as the negative electrode current collector. The sheet-shaped metal material should be a metal foil, a metal porous body, or an etched metal, for example. As the metal material, copper, a copper alloy, nickel, or stainless steel can be used, for example.

### (Electrolytic Solution)

The concentration of the lithium salt in the electrolytic solution is 0.5 mol/L or more and 5 mol/L or less, for example. The lithium salt includes an imide-based lithium salt, and may include a component other than the imide-based lithium salt. The proportion of the imide-based lithium salt in the lithium salt is desirably 50 mol % or more, may be 70 mol % or more, or may be 90 mol % or more. Alternatively, the entire lithium salts may be the imide-based lithium salt.

Examples of the component other than the imide-based lithium salt include LiClO₄, LiBF₄, LiPF₆, LiAlCH₄, LiSbF₆, LiSCN, LiCF₃SO₃, LiFSO₃, LiCF₃CO₂, LiAsF₆, LiB₁₀Cl₁₀, LiCl, LiBr, LiI, and LiBCl₄. These may be used singly or in a combination of two or more.

Examples of the solvent that can be used include: cyclic carbonates such as ethylene carbonate, propylene carbonate, and butylene carbonate; chain carbonates such as dimethyl carbonate, diethyl carbonate, and ethyl methyl carbonate; aliphatic carboxylic esters such as methyl formate, methyl acetate, methyl propionate, and ethyl propionate; lactones such as γ-butyrolactone and γ-valerolactone; chain ethers such as 1,2-dimethoxyethane, 1,2-diethoxyethane, and ethoxy methoxyethane (EME); cyclic ethers such as tetrahydrofuran and 2-methyl tetrahydrofuran; dimethyl sulfoxide; 1,3-dioxolane; formamide; acetamide; dimethylformamide; dioxolane; acetonitrile; propionitrile; nitromethane; ethyl monoglyme; trimethoxy methane; sulfolane; methyl sulfolane; and 1,3-propanesultone. These may be used singly or in combination of two or more.

Among them, the solvent preferably contains a cyclic carbonate and a chain carbonate. In view of suppressing an increase in DCR accompanying float charging, the volume ratio of the cyclic carbonate to the chain carbonate (e.g., the volume ratio of propylene carbonate to ethyl methyl carbonate) is preferably 1/9 to 9/1, and more preferably 2/8 to 8/2.

The cyclic carbonate preferably includes propylene carbonate, and is preferably, substantially free of ethylene carbonate. Noted that the wording “substantially free” means that the content is the detection limit or less in composition analysis of the electrolytic solution. For example, gas chromatography-mass spectrometry (GC/MS), ion chromatography (IC), or nuclear magnetic resonance spectroscopy (NMR) can be used as the composition analysis of the electrolytic solution.

Compared with ethylene carbonate, propylene carbonate has a low melting point and causes the electrolytic solution to solidify less. Therefore, an electrolytic solution containing propylene carbonate can be easily obtained that has a reasonably low viscosity and excellent ion conductivity at low temperatures. In addition, propylene carbonate, which has a methyl group and has a larger steric hindrance than ethylene carbonate, is difficult to decompose into an acid such as HF, with a result that an increase in DCR is easily suppressed.

The proportion of propylene carbonate in the cyclic carbonate may be 30% by volume or more, or may be 50% by volume or more, and may be 80% by volume at most.

The chain carbonate preferably includes ethyl methyl carbonate, and is preferably, substantially free of dimethyl carbonate and diethyl carbonate. In this case, the proportion of ethyl methyl carbonate in the chain carbonate may be 60% by volume or more, or may be 80% by volume or more.

Compared to dimethyl carbonate, ethyl methyl carbonate has a low melting point, is difficult to solidify at low temperatures, and has a low viscosity. Ethyl methyl carbonate has a higher conductivity and a lower viscosity than diethyl carbonate. The DCR at low temperatures can be further reduced when using ethyl methyl carbonate.

Various additives may be contained in the electrolytic solution, as necessary. For example, an unsaturated carbonate such as vinylene carbonate, vinyl ethylene carbonate, or divinylethylene carbonate may be added as an additive for forming a low-resistance coating film on the surface of the negative electrode.

### (Separator)

Preferably, a separator is provided between the positive electrode and the negative electrode. As the separator, a nonwoven fabric made of cellulose fibers, a nonwoven fabric made of glass fibers, a microporous membrane made of polyolefin, a woven fabric, or a nonwoven fabric can be used. The thickness of the separator is 8 to 300 μm, for example, and preferably 8 to 40 μm.

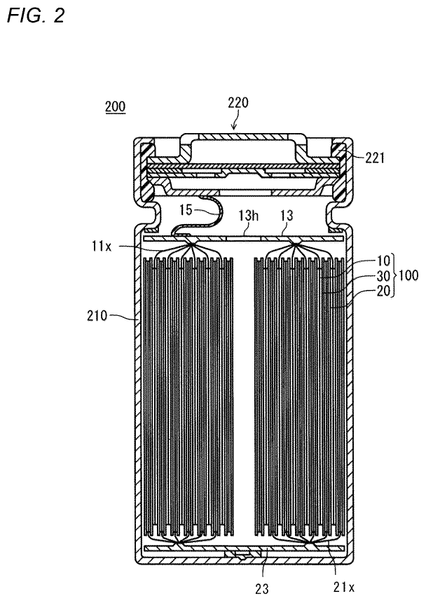

FIG. 2 is a longitudinal sectional view of an example of an electrochemical device. An electrochemical device 200 includes an electrode body 100, an electrolytic solution (not illustrated), a bottomed metal cell case 210 accommodating the electrode body 100 and the electrolytic solution, and a sealing plate 220 that seals the opening of the cell case 210. The electrode body 100 is a columnar wound body configured of a belt-shaped positive electrode 10 and a belt-shaped negative electrode 20 wound with a separator 30 between the positive electrode 10 and the negative electrode 20. A gasket 221 is provided at a periphery of the sealing plate 220. The inside of the cell case 210 is sealed by crimping the open end of the cell case 210 to the gasket 221. A positive electrode current collector plate 13 having a through hole 13h in the center thereof is welded to a positive electrode core material exposed portion 11x. One end of a tab lead 15, the other end of which is connected to the positive electrode current collector plate 13, is connected to the inner surface of the sealing plate 220. In the above configuration, the sealing plate 220 functions as an external positive electrode terminal. On the other hand, a negative electrode current collector plate 23 is welded to a negative electrode core material exposed portion 21x. The negative electrode current collector plate 23 is directly welded to a welding member provided on the inner bottom surface of the cell case 210. In the above configuration, the cell case 210 functions as an external negative electrode terminal.

The positive electrode current collector plate 13 is a substantially disk-shaped metal plate. Preferably, a through hole serving as a passage for the electrolytic solution is formed in the central part of the positive electrode current collector plate. Examples of the material of the positive electrode current collector plate include aluminum, an aluminum alloy, titanium, and stainless steel. The material of the positive electrode current collector plate may be the same as the material of the positive electrode current collector.

The negative electrode current collector plate 23 is a substantially disk-shaped metal plate. Examples of the material of the negative electrode current collector plate include copper, a copper alloy, nickel, and stainless steel. The material of the negative electrode current collector plate may be the same as the material of the negative electrode current collector.

The electrochemical device is not limited to the electrochemical device of wound type illustrated in FIG. 2. For example, it may be an electrochemical device of stacked type. That is, the electrode body may be configured as a stacked body in which a sheet-like positive electrode and a sheet-like negative electrode are stacked with the separator between the positive and negative electrodes.

### SUPPLEMENTAL REMARKS

According to the above description of the embodiments, the following techniques are disclosed.

### (Technique 1)

An electrochemical device including:
a positive electrode containing a positive electrode active material reversibly doped with anions;
a negative electrode containing a negative electrode active material reversibly doped with lithium ions; and
an electrolytic solution containing a solvent and a lithium salt, wherein
the lithium salt includes an imide-based lithium salt,
the positive electrode active material contains a porous carbon material, and
a total surface functional group amount F (meq/g) per unit mass of the porous carbon material and an area S (nm²) of a circle having an average pore diameter of the porous carbon material as a diameter thereof satisfy a relationship of 0.01≤F/S≤0.2.

### (Technique 2)

The electrochemical device of Technique 1, wherein the imide-based lithium salt include lithium bis(fluorosulfonyl) imide.

### (Technique 3)

The electrochemical device of Technique 1 or 2, wherein the solvent contains a cyclic carbonate and a chain carbonate.

### (Technique 4)

The electrochemical device according to Technique 3, wherein a volume ratio of the cyclic carbonate to the chain carbonate is ¼ or more and 4 or less.

### (Technique 5)

The electrochemical device of Technique 3 or 4, wherein the cyclic carbonate includes propylene carbonate, and is substantially free of ethylene carbonate.

### (Technique 6)

The electrochemical device of any one of Techniques 3 to 5, wherein the chain carbonate includes ethyl methyl carbonate, and is substantially free of dimethyl carbonate and diethyl carbonate.

### (Technique 7)

The electrochemical device of any one of Techniques 1 to 6, wherein the negative electrode active material contains hard carbon.

### EXAMPLES

Hereinafter, the present disclosure will be described in more detail based on examples, but the present disclosure is not limited to the examples.

### <<Devices A1 to A14 and Devices B1 to B18>>

### (Positive Electrode Production)

A positive electrode mixture slurry was obtained by dispersing 88 parts by mass of a positive electrode active material, 2 parts by mass of polytetrafluoroethylene (PTFE), 4 parts by mass of carboxymethyl cellulose, and 6 parts by mass of acetylene black in water. The positive electrode mixture slurry was applied onto both surfaces of an aluminum foil (thickness: 30 μm) serving as a positive electrode current collector, and the resulting coating films were dried and rolled to form positive electrode mixture layers, thereby obtaining a positive electrode.

As the positive electrode active material, any of the porous carbon materials (activated carbon particles) a1 to a14, b1, and b2 shown in Table 1 was used.

TABLE 1

| | | | Total surface | Area S of circle | Total surface |
|---|---|---|---|---|---|
| Porous | Specific | Average | functional | with average pore | functional group |
| carbon | surface | pore | group amount F | diameter d as | density D |
| material | area A | diameter d | per unite mass | diameter | (=F/S) |
| No. | (m²/g) | (nm) | (meq/g) | (nm²) | (meq/g/nm²) |
| a1 | 1200 | 6.0 | 0.35 | 28.3 | 0.012 |
| a2 | 2100 | 2.5 | 0.07 | 4.9 | 0.014 |
| a3 | 1600 | 2.3 | 0.07 | 4.2 | 0.017 |
| a4 | 1100 | 1.9 | 0.07 | 2.9 | 0.024 |
| a5 | 1900 | 2.0 | 0.10 | 3.1 | 0.032 |
| a6 | 1649 | 2.1 | 0.16 | 3.4 | 0.048 |
| a7 | 2000 | 2.2 | 0.20 | 3.8 | 0.053 |
| a8 | 1900 | 2.8 | 0.45 | 6.1 | 0.074 |
| a9 | 2500 | 1.8 | 0.20 | 2.4 | 0.082 |
| a10 | 1800 | 1.6 | 0.17 | 2.0 | 0.086 |
| a11 | 2300 | 2.0 | 0.30 | 3.1 | 0.096 |
| a12 | 1800 | 2.2 | 0.50 | 3.8 | 0.132 |
| a13 | 1500 | 2.7 | 0.95 | 5.9 | 0.161 |
| a14 | 2200 | 1.8 | 0.50 | 2.5 | 0.197 |
| b1 | 2700 | 2.0 | 0.80 | 3.1 | 0.255 |
| b2 | 1000 | 7.0 | 0.25 | 38.5 | 0.006 |

### (Negative Electrode Production)

A negative electrode mixture slurry was obtained by dispersing 90 parts by mass of hard carbon, 5 parts by mass of Ketjen black, 1.5 parts by mass of carboxymethyl cellulose, and 3 parts by mass of styrene butadiene rubber in water. The negative electrode mixture slurry was applied onto both surfaces of a copper foil (thickness 8 μm) serving as a negative electrode current collector to form coating films, and the resulting coating films were dried and rolled to form negative electrode mixture layers, thereby obtaining a negative electrode.

Next, a specific quantity of metal lithium foil was attached to one of the negative electrode mixture layers. The specific quantity was calculated so that the negative electrode potential in the electrolytic solution after pre-doping was completed would become 0.2 V or lower relative to the metal lithium

### (Electrode Body Production)

Any of the positive electrodes and the negative electrode were wound into a columnar shape with a separator (thickness: 25 μm) made of a cellulose nonwoven fabric therebetween to form an electrode body. In doing so, a positive electrode current collector exposed portion was made to protrude from one end surface of the electrode body, and a negative electrode current collector exposed portion was made to protrude from the other end surface of the electrode body. Disc-shaped positive electrode current collector plate and negative electrode current collector plate were welded to the positive electrode current collector exposed portion and the negative electrode current collector exposed portion, respectively.

### (Electrolytic Solution Preparation)

Electrolytic solutions were prepared by dissolving a lithium salt in a solvent. As the solvent, a mixture of a cyclic carbonate and a chain carbonate in a volume ratio of 30:70 was used. Propylene carbonate (PC) and ethyl methyl carbonate (EMC) were used as the cyclic carbonate and the chain carbonate, respectively. LiFSI or LiPF₆ was used as the lithium salt. The concentration of the lithium salt (LiFSI or LiPF₆) in the electrolytic solution was set to 1.0 mol/L.

### (Electrochemical Device Assembly)

Any of the electrode bodies was housed in a bottomed cell case having an opening. A tab lead connected to the positive electrode current collector plate was connected to the inner surface of a sealing plate. Further, the negative electrode current collector plate was welded to the inner bottom surface of the cell case. After the electrolytic solution was filled in the cell case, the opening of the cell case was blocked with the sealing plate, thereby assembling an electrochemical device as illustrated in FIG. 2. A1 to A14 in Table 2 correspond to the electrochemical devices of Examples. B1 and B2 in Table 2 and B3 to B18 in Table 3 correspond to electrochemical devices of Comparative Examples.

Thereafter, pre-doping of the lithium ion into the negative electrode was allowed to progress by aging at 25° C. for 24 hours while applying a charging voltage of 3.8 V between the terminals of the positive electrode and the negative electrode.

The following evaluations were performed on the electrochemical devices.

### [Evaluation]

### (Determination of Internal Resistances (DCR) of Electrochemical Devices in Initial Stage)

With respect to each of the electrochemical devices immediately after aging, constant current charging at a current density of 2 mA/cm² per positive electrode area was performed in a −30° C. environment until the voltage became 3.8 V. Thereafter, the electrochemical device was held for 10 minutes in a state in which a voltage of 3.8 V was applied. Subsequently, constant current discharging at a current density of 2 mA/cm² per positive electrode area was performed in a −30° C. environment until the voltage became 2.2 V.

Using a discharge curve (vertical axis: discharging voltage, horizontal axis: discharge time) obtained by the above discharging, a first-order approximate straight line in the discharge curve in a range of 0.5 seconds to 2 seconds after the start of the discharging was obtained, and a voltage VS of an intercept of the approximate straight line was determined. The value (V0-VS) obtained by subtracting the voltage VS from the voltage V0 at the start of the discharging (at the time when 0 seconds elapsed from the start of the discharging) was obtained as ΔV. Using ΔV (V) and the current value (current density 2 mA/cm² per positive electrode area×positive electrode area) Id at the discharging, an internal resistance R1 (Ω) of the electrochemical device was determined from the following equation (A).

$$Internal resistance R 1 = Δ V / Id \qquad ( A )$$

(Determination of Internal Resistances (DCR) of Electrochemical Devices after Float Test)

Next, a float test was performed by holding the electrochemical device for 1000 hours while a constant voltage of 3.8 V was applied to the electrochemical device in an 85° C. environment. Thereafter, an internal resistance R2 (Ω) of the electrochemical device was determined in the same manner as that for determining R1 described above.

Using R1 and R2 thus obtained, a DCR change rate (%) was determined from the following equation (B).

$$DCR change rate = \{ ( R 2 - R 1 ) / R 1 \} \times 100 \qquad ( B )$$

The lower the DCR change rate, the more the increase in internal resistance is inhibited and the higher the reliability.

The evaluation results are shown in Tables 2 and 3.

TABLE 2

| | | Electrolytic solution | | | | | Floating |
|---|---|---|---|---|---|---|---|
| | Porous | | Solvent | | | | characteristics |
| | carbon | | Cyclic carbonate | | Chain carbonate | | DCR |
| Electrochemical | material | Lithium | | Content | | Content | change rate |
| device No. | No. | salt | Compound | (% by volume) | Compound | (% by volume) | (%) |
| A1 | a1 | LiFSI | PC | 30 | EMC | 70 | 16.4 |
| A2 | a2 | LiFSI | PC | 30 | EMC | 70 | 15.5 |
| A3 | a3 | LiFSI | PC | 30 | EMC | 70 | 14.4 |
| A4 | a4 | LiFSI | PC | 30 | EMC | 70 | 12.7 |
| A5 | a5 | LiFSI | PC | 30 | EMC | 70 | 13.7 |
| A6 | a6 | LiFSI | PC | 30 | EMC | 70 | 15.8 |
| A7 | a7 | LiFSI | PC | 30 | EMC | 70 | 15.2 |
| A8 | a8 | LiFSI | PC | 30 | EMC | 70 | 11.1 |
| A9 | a9 | LiFSI | PC | 30 | EMC | 70 | 14.4 |
| A10 | a10 | LiFSI | PC | 30 | EMC | 70 | 16.2 |
| A11 | a11 | LiFSI | PC | 30 | EMC | 70 | 14.8 |
| A12 | a12 | LiFSI | PC | 30 | EMC | 70 | 16.2 |
| A13 | a13 | LiFSI | PC | 30 | EMC | 70 | 12.7 |
| A14 | a14 | LiFSI | PC | 30 | EMC | 70 | 16.2 |
| B1 | b1 | LiFSI | PC | 30 | EMC | 70 | 54.7 |
| B2 | b2 | LiFSI | PC | 30 | EMC | 70 | 33.7 |

TABLE 3

| | | Electrolytic solution | | | | | Floating |
|---|---|---|---|---|---|---|---|
| | Porous | | Solvent | | | | characteristics |
| | carbon | | Cyclic carbonate | | Chain carbonate | | DCR |
| Electrochemical | material | Lithium | | Content | | Content | change rate |
| device No. | No. | salt | Compound | (% by volume) | Compound | (% by volume) | (%) |
| B3 | a1 | LiPF₆ | PC | 30 | EMC | 70 | 44.2 |
| B4 | a2 | LiPF₆ | PC | 30 | EMC | 70 | 46.3 |
| B5 | a3 | LiPF₆ | PC | 30 | EMC | 70 | 40.6 |
| B6 | a4 | LiPF₆ | PC | 30 | EMC | 70 | 81.2 |
| B7 | a5 | LiPF₆ | PC | 30 | EMC | 70 | 51.1 |
| B8 | a6 | LiPF₆ | PC | 30 | EMC | 70 | 52.4 |
| B9 | a7 | LiPF₆ | PC | 30 | EMC | 70 | 81.1 |
| B10 | a8 | LiPF₆ | PC | 30 | EMC | 70 | 51.4 |
| B11 | a9 | LiPF₆ | PC | 30 | EMC | 70 | 51.8 |
| B12 | a10 | LiPF₆ | PC | 30 | EMC | 70 | 65.4 |
| B13 | a11 | LiPF₆ | PC | 30 | EMC | 70 | 48.7 |
| B14 | a12 | LiPF₆ | PC | 30 | EMC | 70 | 48.4 |
| B15 | a13 | LiPF₆ | PC | 30 | EMC | 70 | 84.7 |
| B16 | a14 | LiPF₆ | PC | 30 | EMC | 70 | 48.4 |
| B17 | b1 | LiPF₆ | PC | 30 | EMC | 70 | 38.8 |
| B18 | b2 | LiPF₆ | PC | 30 | EMC | 70 | 51.4 |

Each of the devices A1 to A14 had a smaller DCR change rate than the devices B1 to B18. As such, the increase in the internal resistance was suppressed.

### <<Devices A15 to A26>>

In the electrolytic solution preparation, the contents of the cyclic carbonate and the chain carbonate in the solvent were set to the respective values (% by volume) shown in Table 4. The respective compounds shown in Table 4 were used as the cyclic carbonate and the chain carbonate. In Table 4, EC refers to ethylene carbonate, DMC refers to dimethyl carbonate, and DEC refers to diethyl carbonate. In Table 4, in each of the devices A22 to A26, two compounds were used for the cyclic carbonate (and for the chain carbonate as necessary). The volume ratio of the two compounds are shown in parentheses.

Devices A15 to A26 were produced and evaluated in the same manner as those for the device A8 except for the above. The evaluation results of the devices A15 to A26 are shown in Table 4 together with those of the device A8.

TABLE 4

| | | Electrolytic solution | | | | | Floating |
|---|---|---|---|---|---|---|---|
| | Porous | | Solvent | | | | characteristics |
| | carbon | | Cyclic carbonate | | Chain carbonate | | DCR |
| Electrochemical | material | Lithium | | Content | | Content | change rate |
| device No. | No. | salt | Compound | (% by volume) | Compound | (% by volume) | (%) |
| A15 | a8 | LiFSI | PC | 10 | EMC | 90 | 44.9 |
| A16 | a8 | LiFSI | PC | 20 | EMC | 80 | 14.7 |
| A8 | a8 | LiFSI | PC | 30 | EMC | 70 | 11.1 |
| A17 | a8 | LiFSI | PC | 70 | EMC | 30 | 8.7 |
| A18 | a8 | LiFSI | PC | 80 | EMC | 20 | 7.9 |
| A19 | a8 | LiFSI | PC | 90 | EMC | 10 | 33.6 |
| A20 | a8 | LiFSI | PC | 50 | DMC | 50 | 18.7 |
| A21 | a8 | LiFSI | PC | 50 | DEC | 50 | 17.5 |
| A22 | a8 | LiFSI | PC + EC | 50 | EMC | 50 | 19.7 |
| A23 | a8 | LiFSI | (PC/EC = 4) | | DMC | 50 | 25.7 |
| A24 | a8 | LiFSI | | | DEC | 50 | 23.5 |
| A25 | a8 | LiFSI | | | EMC + DMC | 50 | 24.8 |
| | | | | | (EMC/DMC = 4) | | |
| A26 | a8 | LiFSI | | | EMC + DEC | 50 | 22.7 |
| | | | | | (EMC/DEC = 4) | | |

In each of the devices A15 to A26, the DCR change rate became small by using the porous carbon material a8 for the positive electrode active material and using LiFSI for the lithium salt of the electrolytic solution, similarly to the case of the device A8. In the devices A8 and A16 to A18 in each of which the volume ratio PC/EMC was ¼ or more and 4 or less and EC, DMC, and DEC were substantially not contained in the electrolytic solution, the DCR change rate was further reduced.

### INDUSTRIAL APPLICABILITY

The electrochemical device according to the present disclosure is suitable for in-vehicle use, for example.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted to cover all alterations and modifications as fall within the true spirit and scope of the invention.

### REFERENCE SIGNS LIST

1: porous carbon material, 2: pore, 3: inner wall surface of pore, 4: acidic functional group, 5: electrolytic solution, 6: solvent, 7: anion, 10: positive electrode, 11x: positive electrode core material exposed portion, 13: positive electrode current collector plate, 15: tab lead, 20: negative electrode, 21x: negative electrode core material exposed portion, 23: negative electrode current collector plate, 30: separator, 100: electrode body, 200: electrochemical device, 210: cell case, 220: sealing plate, 221: gasket

1. An electrochemical device comprising:
a positive electrode containing a positive electrode active material reversibly doped with anions;
a negative electrode containing a negative electrode active material reversibly doped with lithium ions; and
an electrolytic solution containing a solvent and a lithium salt, wherein
the lithium salt includes an imide-based lithium salt,
the positive electrode active material contains a porous carbon material, and
a total surface functional group amount F (meq/g) per unit mass of the porous carbon material and an area S (nm²) of a circle having an average pore diameter of the porous carbon material as a diameter thereof satisfy a relationship of 0.01≤F/S≤0.2.

2. The electrochemical device according to claim 1, wherein
the imide-based lithium salt include lithium bis(fluorosulfonyl) imide.

3. The electrochemical device according to claim 1, wherein
the solvent contains a cyclic carbonate and a chain carbonate.

4. The electrochemical device according to claim 3, wherein
a volume ratio of the cyclic carbonate to the chain carbonate is ¼ or more and 4 or less.

5. The electrochemical device according to claim 3, wherein
the cyclic carbonate includes propylene carbonate, and is substantially free of ethylene carbonate.

6. The electrochemical device according to claim 3, wherein
the chain carbonate includes ethyl methyl carbonate, and is substantially free of dimethyl carbonate and diethyl carbonate.

7. The electrochemical device according to claim 1, wherein
the negative electrode active material contains hard carbon.
